(19) United States
(12) Patent Application Publication
(10) Pub. No.: US 2017/0371426 A1
(43) Pub. Date: Dec. 28, 2017

(54) DISPLAY APPARATUS AND METHOD FOR CONTROLLING DISPLAY APPARATUS

(71) Applicant: SEIKO EPSON CORPORATION, Tokyo (JP)

(72) Inventor: Takahiro ANO, Matsumoto-shi (JP)

(73) Assignee: SEIKO EPSON CORPORATION, Tokyo (JP)

(21) Appl. No.: 15/625,147

(22) Filed: Jun. 16, 2017

(30) Foreign Application Priority Data
Jun. 27, 2016 (JP) 2016-126615

(51) Int. Cl. G06F 3/038; G06F 3/0354; G09G 5/00; G06F 3/0482

(52) U.S. Cl. CPC G06F 3/038; G09G 5/006; G06F 3/03545; G06F 3/0482; G09G 2354/00

(57) ABSTRACT

When position information is outputted, in a case where the correspondence between a first interface via which an image signal is inputted and a second interface via which the position information is outputted has not been stored, it is evaluated whether a candidate of the second interface is uniquely determined. When the candidate is not uniquely determined, an output destination identification image is displayed, and an output destination selected in the output destination identification image is stored in a management table. When the correspondence between the first interface and the second interface has been stored, it is evaluated whether a no output destination has been stored in the management table, and when the no output destination does not apply, the position information is transmitted.

### CROSS-REFERENCE

The entire disclosure of Japanese Patent Application No. 2016-126615, filed Jun. 27, 2016 is expressly incorporated by reference herein.

### BACKGROUND

### 1. Technical Field

The present invention relates to a display apparatus that displays an image and a method for controlling the display apparatus.

### 2. Related Art

A projector having an interactive function has been known in recent years. A projector of this type is connected to a personal computer (hereinafter referred to as PC) in use, displays an image based on an image signal outputted from the PC on a screen, and accepts operation performed with a pointing element, such as a pen tool and a user's finger. In a case where the projector is used in a conference or any other occasion, the user, for example, causes the projector to display an image of a document on the screen, stands by the screen, and give a presentation while referring to the image in some cases. During the presentation, when the user desires to open another file and display a new image, it is cumbersome for the user to return to the PC and operate it. To avoid such cumbersomeness, the projector has an operation mode that allows the user to use the pointing element as a pointing device associated with the PC. In the operate mode, the projector detects position information representing the position where the pointing element comes into contact with a display surface and transmits the position information to the PC. The thus configured projector is described, for example, in JP-A-2007-265171.

The projector disclosed in JP-A-2007-265171 is connected to a single PC and acts in the operation mode.

In the projector of the related art, however, it is not intended that a plurality of PCs are connected to the projector. Therefore, when the source of the image signal displayed by the projector is switched from a PC to another, the destination to which the position information is outputted is undesirably not changed.

For example, consider a state in which the projector is displaying an image based on an image signal outputted from a first PC and transmitting the information on the position of the pointing element to the first PC via a USB cable. In this state, when the source from which an image displayed on the screen is inputted is switched from the first PC to a second PC, and the pointing element is used to operate a pointing device associated with the first PC, the first PC is operated while the projector displays an image transmitted from the second PC. Unintended operation, such as deletion of a file, could therefore be undesirably performed on the first PC.

### SUMMARY

An advantage of some aspects of the invention is to provide a display apparatus that prevents a user's unintended operation from being performed on an external apparatus to which position information is outputted, and another advantage of some aspects of the invention is to provide a method for controlling the display apparatus.

One aspect of a display apparatus according to the invention includes a plurality of interfaces, a display section that displays a first image according to an image signal on a display surface, a detection section that detects a position of a pointing element on the display surface and generates position information representing the position of the pointing element, a storage section that stores a correspondence between a first interface which is one of the plurality of interfaces and via which the image signal is inputted and a second interface which is one of the plurality of interfaces and via which the position information is outputted, and a control section that carries out the process of outputting the position information via the second interface in a case where the display section is displaying the first image according to the image signal inputted via the first interface and the storage section has stored the correspondence between the first interface and the second interface and when the detection section detects the position of the pointing element and identifying an interface via which the position information is outputted in a case where the display section is displaying the first image according to the image signal inputted via the first interface and the storage section has not stored the correspondence between the first interface and the second interface and after the detection section detects the position of the pointing element.

According to the aspect described above, in the case where the storage section has stored the correspondence between the first interface and the second interface, and when the detection section detects the position of the pointing element, the control section outputs the position information on the position of the pointing element via the second interface corresponding to the first interface. On the other hand, in the case where the storage section has not stored the correspondence between the first interface and the second interface, and after the detection section detects the position of the pointing element, the control section carries out the process of identifying an interface via which the position information is outputted. As described above, in a case where the second interface via which the position information is outputted is unknown, the process of identifying an interface via which the position information is outputted is carried out, whereby a situation in which a user performs unintended operation on an external apparatus that is the destination to which the position information on the position of the pointing element is outputted can be avoided. Even when a new external apparatus is connected to the display apparatus and an image signal is inputted thereto, an image based on the image signal is not displayed in some cases. According to the aspect described above, since the process of identifying an interface via which the position information is outputted is carried out after the detection section detects the position of the pointing element, the user's effort of setting a destination to which the position information is outputted can be reduced.

In the aspect of the display apparatus described above, in the process, the control section may cause the display section to display a second image containing, as a target to be selected, at least interfaces that are candidates of the second interface corresponding to the first interface, and when one of the candidate interfaces is selected, the control section may cause the storage section to store the correspondence between the first interface and the second interface that is the selected one interface. According to the aspect described above, since the display section displays the second image containing, as a target to be selected, at least interfaces that are candidates of the second interface corresponding to the first interface, the output destination interface can be identified when the user selects any of the candidate interfaces.

In the aspect of the display apparatus described above, in the process, the control section may cause the display section to display the second image containing a no output destination as a target to be selected in addition to the candidate interfaces, and when the no output destination is selected, the control section may cause the storage section to store a correspondence between the first interface and the no output destination. According to the aspect described above, when the no output destination is selected, a situation in which the information on the position of the pointing element is outputted to a wrong destination is avoided, whereby wrong action is avoided.

In the aspect of the display apparatus described above, in the process, in a case where an interface that is a candidate of the second interface corresponding to the first interface is uniquely determined, the control section may not cause the display section to display the second image but may cause the storage section to store a correspondence between the first interface and the uniquely determined second interface. According to the aspect described above, in a case where a candidate interface is uniquely determined so that the necessity of prompting the user to select an interface is low, the correspondence between the first interface and the second interface is automatically stored. Therefore, According to the aspect described above, cumbersomeness of causing the user to set a destination to which the position information is outputted can be eliminated.

In a case where the first interface is an interface capable of inputting the image signal and outputting the position information, the control section preferably causes the storage section to store the correspondence between the first interface, via which the image signal is inputted, and the first interface, via which the position information is outputted, without causing the display section to display the second image. The reason for this is that in the case where the interface via which the image signal is inputted is capable of outputting the position information, the interface allows output of the position information without use of any other interface.

In the aspect of the display apparatus described above, in a case where the first interface is connected to an external apparatus and the storage section has stored the correspondence between the first interface and the second interface, and when the first interface is not connected to the external apparatus, the control section may cancel the correspondence stored in the storage section between the first interface and the second interface. When the first interface is not connected to the external apparatus, a new external apparatus is likely to be connected to the display apparatus. According to the aspect described above, since the correspondence between the first interface and the second interface is canceled when the first interface is not connected to the external apparatus, a situation in which the position information on the position of the pointing element is wrongly outputted to the prior external apparatus is avoided.

In the aspect of the display apparatus described above, in a case where the first interface is connected to an external apparatus and the storage section has stored the correspondence between the first interface and the second interface, and when a state in which the image signal is not inputted from the external apparatus to the first interface has continued for a predetermined period, the control section may cancel the correspondence stored in the storage section between the first interface and the second interface. In the case where the state in which the image signal is not inputted from the external apparatus to the first interface has continued for a predetermined period, a new external apparatus is likely to be connected to the display apparatus. According to the aspect described above, since the correspondence between the first interface and the second interface is canceled, the situation in which the position information on the position of the pointing element is wrongly outputted to the prior external apparatus is avoided.

In the aspect of the display apparatus described above, in a case where the second interface is connected to an external apparatus and the storage section has stored the correspondence between the first interface and the second interface, and when the second interface is not connected to the external apparatus, the control section may cancel the correspondence stored in the storage section between the first interface and the second interface. When the second interface is not connected to the external apparatus, the destination to which the position information is outputted is likely to be changed. According to the aspect described above, since the correspondence between the first interface and the second interface is canceled, a situation in which the position information on the position of the pointing element is wrongly outputted to the external apparatus connected to the second interface again is avoided.

In the aspect of the display apparatus described above, the control section may switch an action mode of the display apparatus between a mode in which the position information is outputted and a mode in which drawing is performed on the display surface based on the position information. According to the aspect described above, an appropriate process can be carried out in accordance with each of the modes.

Another aspect of a method for controlling a display apparatus according to the invention includes acquiring position information representing a position of an pointing element on a display surface on which a first image according to an image signal is displayed, storing a correspondence between a first interface which is one of a plurality of interfaces and via which the image signal is inputted and a second interface which is one of the plurality of interfaces and via which the position information is outputted, and carrying out the process of outputting the position information via the second interface in a case where the display section is displaying the first image according to the image signal inputted via the first interface and the storage section has stored the correspondence between the first interface and the second interface and after the position of the pointing element is acquired and identifying an interface via which the position information is outputted in a case where the display section is displaying the first image according to the image signal inputted via the first interface and the storage section has not stored the correspondence between the first interface and the second interface and after the position of the pointing element is acquired.

According to the aspect described above, in the case where the storage section has not stored the correspondence between the first interface and the second interface, the control section carries out the process of identifying an interface via which the position information is outputted after the detection section detects the position of the pointing element. In the case where the second interface via which the position information is outputted is unknown, the process of identifying an interface via which the position information is outputted is carried out as described above, whereby a situation in which the user performs unintended operation on an external apparatus that is the destination to which the position information on the position of the pointing element is outputted can be avoided.

### BRIEF DESCRIPTION OF THE DRAWINGS

The invention will be described with reference to the accompanying drawings, wherein like numbers reference like elements.

FIG. 1 shows the configuration of a projection system according to an embodiment of the invention.

FIG. 2 is a block diagram showing the configuration of a projector.

FIG. 3 shows examples of interfaces provided in an I/F section.

FIG. 4 is a descriptive diagram showing connection forms in accordance with which the projector and a PC are connected to each other.

FIG. 5 shows an example of contents stored in a management table.

FIG. 6 is a flowchart showing the action of the projector in an operation mode.

FIG. 7 shows an example of an output destination identification image.

FIG. 8 is a flowchart showing the contents of the process of updating the management table.

FIG. 9 is a block diagram showing an example of connection between the projector and PCs.

FIG. 10 shows an example of the contents stored in the management table.

FIG. 11 shows an example of the contents stored in the management table.

FIG. 12 is a block diagram showing an example of connection between the projector and PCs.

FIG. 13 shows an example of the contents stored in the management table.

FIG. 14 shows an example of connection between the projector and the PCs.

FIG. 15 shows an example of the management table.

FIG. 16 shows an example of connection between the projector and the PCs.

FIG. 17 shows an example of the output destination identification image.

FIG. 18 shows an example of the management table.

FIG. 19 shows an example of an input source identification image.

FIG. 20 is a flowchart showing a process carried out when an input source is selected via a network.

### DESCRIPTION OF EXEMPLARY EMBODIMENTS

A preferable embodiment of the invention will be described below in detail with reference to the accompanying drawing and the like. In the drawings, the dimension and scale of each portion differ from actual values as appropriate. Further, since the embodiment described below is a preferable specific example of the invention, a variety of technically preferable restrictions are imposed on the embodiment, but the scope of the invention is not limited to the restricted forms unless otherwise particularly stated in the following description that a restriction is imposed on the invention.

### 1. Configuration of Projection System

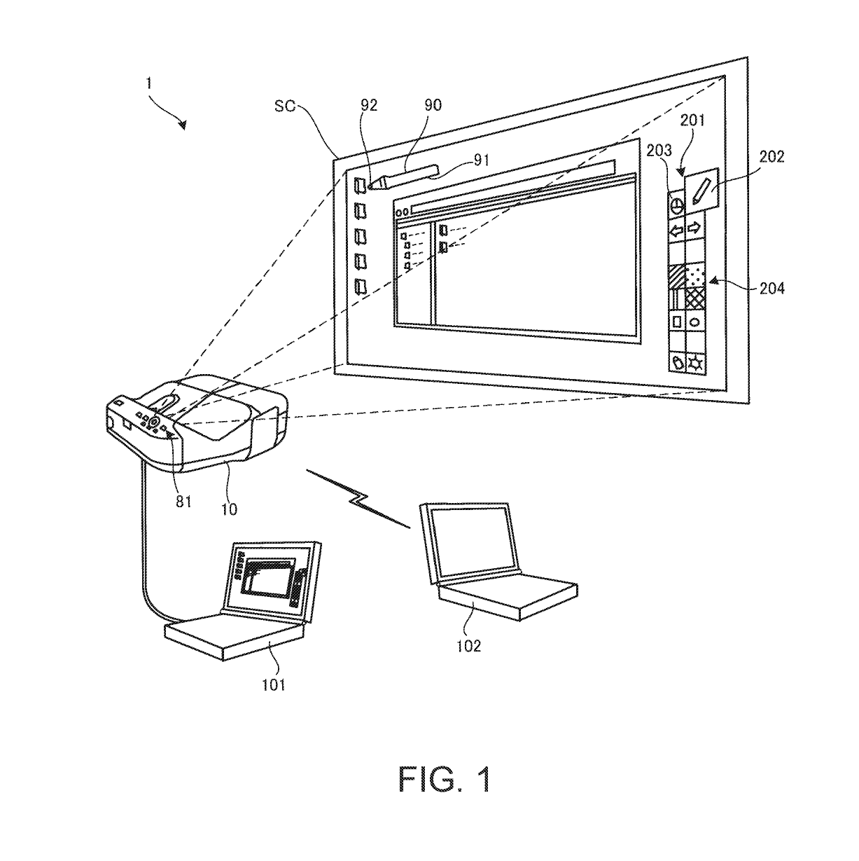

FIG. 1 shows the configuration of a projection system 1 according to a first embodiment to which the invention is applied. The projection system 1 includes a projector 10, which serves as a display apparatus installed in front of a screen SC, and a PC, which serves as an external apparatus. The example shown in FIG. 1 shows a state in which a PC 101 and a PC 102 are connected to the projector 10. It is, however, noted in the embodiment of the invention that the number of PCs connected to the projector 10 is not limited to two and can be changed as appropriate, as will be described later. The projector 10 is an example of a display apparatus that displays an image, and the display apparatus according to an aspect of the invention is not limited to the projector 10.

The projector 10, to which an image signal outputted from the PC 101 or a PC, such as the PC101, is inputted, displays a first image according to the image signal on the screen SC, which serves as a display surface. The projector 10 can display not only an image based on an image signal transmitted from a PC (first image) but also an image based on an image signal stored in the projector 10 and an image generated in the projector 10 on the screen SC. An example of the image generated in the projector 10 includes an image that allows a user to select the destination to which information on the position of a pointing element 90 is outputted (second image).

In the example shown in FIG. 1, the projector 10 is installed in front of the screen SC and projects an image in an obliquely upward direction. It is, however, noted that the projector can instead be installed immediately above the screen SC and can project an image in an obliquely downward direction. The screen SC is not limited to a flat plate fixed to a wall surface, and the wall surface itself can also be used as the screen SC.

The pointing element 90 is, for example, a pen-shaped device and includes a shaft 91 and a front end button 92. The user, when using the pointing element 90, holds the shaft 91 with a hand and presses the front end button 92 against the screen SC or an image on the screen SC. The front end button 92 interlocks with a switch provided in the pointing element 90, and when the front end button 92 is pressed, the switch is turned on. An infrared light emitter is provided in the pointing element 90, and when the switch is turned on, the infrared light emitter outputs a signal representing that the switch has been turned on. The infrared light emitter includes, for example, a light emitting device, such as an infrared LED, a light emission control circuit, and a power supply. The infrared light emitter cyclically emits infrared light after the pointing element 90 is power on. The infrared light emitter transmits data representing the on/off state of the switch, which interlocks with the front end button 92, in accordance with a method that complies, for example, with IrDA (Infrared Data Association).

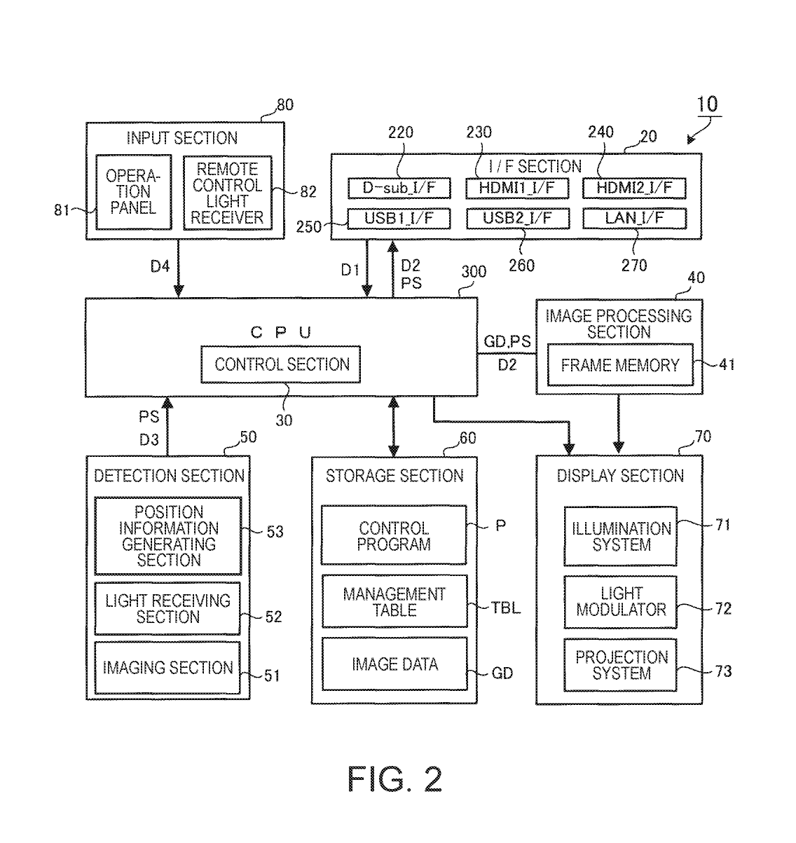

The projector 10 includes a detection section 50 (see FIG. 2), which detects the position of the pointing element 90 on the screen SC, as will be described later. The detection section 50 detects the position on the screen SC against which the front end button 92 of the pointing element 90 is pressed as the position of the pointing element 90 on the screen SC, which serves as the display surface, and generates position information PS representing the position of the pointing element 90.

The projector 10 has a drawing mode and an operation mode. In the drawing mode, the trajectory of the pointing element 90 is drawn as a line drawing on the screen SC on the basis of the position information PS, which is generated by the detection section 50 and represents the position of the pointing element 90. In the operation mode, the position information PS is outputted to a PC connected to the projector 10, such as the PC 101, and the user can perform the same operation performed on the PC with a pointing device, such as what is called a mouse, by pointing an image displayed on the screen SC with the pointing element 90. In the operation mode, the position information PS, which represents the position of the pointing element 90, is used as the coordinates where the pointing device associated with the PC performs input operation.

A toolbar 201 is projected along with a projection image on the screen SC, as shown in FIG. 1. A plurality of function buttons 204 and the like, which allow the projector 10 to carry out a variety of functions, are arranged in the toolbar 201. When the pointing element 90 is pressed against the screen SC in the position of any of the function buttons 204, the projector 10 carries out the function allocated to the pressed function button 204.

A drawing mode switching button 202 and an operation mode switching button 203 are also arranged in the toolbar 201. When the pointing element 90 is pressed against the screen SC in the position of the drawing mode switching button 202, the action mode of the projector 10 is switched to the drawing mode. When the pointing element 90 is pressed against the screen SC in the position of the operation mode switching button 203, the action mode of the projector 10 is switched to the operation mode. FIG. 1 shows the state in which the action mode has been switched to the operation mode.

The user can operate the projector 10 by pressing a button on an operation panel 81 shown in FIG. 1. The user can also operate the projector 10 by pressing a button on a remote control that is not shown.

The configuration of the projector 10 according to the present embodiment will next be described. FIG. 2 shows functional blocks of the projector 10. The projector 10 includes an interface (hereinafter referred to as I/F as appropriate) section 20, an image processing section 40, the detection section 50, a storage section 60, a display section 70, an input section 80, and a CPU (central processing unit) 300, as shown in FIG. 2. The CPU 300 functions as a control section 30, which controls the overall projector 10 by executing a control program P stored in the storage section 60.

The I/F section 20 includes a plurality of interfaces for connecting the projector 10 to an external apparatus, such as a PC, a video reproducing apparatus, and a DVD reproducing apparatus. Each of the interfaces includes a terminal to be connected to the external apparatus and further includes at least one of an input circuit that converts a signal inputted from the external apparatus into a signal that can be handled in the projector 10 and an output circuit that converts a signal in the projector 10 into a signal outputted to the external apparatus.

The I/F section 20 in this example includes a plurality of interfaces, such as a D-sub_I/F 220, an HDMI1_I/F 230, an HDMI2_I/F 240, a USB1_I/F 250, a USB2_I/F 260, and a LAN_I/F 270.

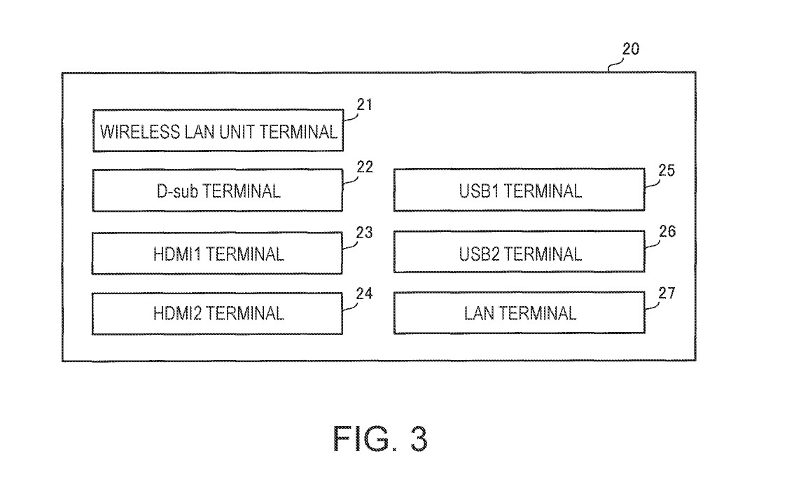

FIG. 3 shows examples of the terminals of the interfaces provided in the I/F section 20. The I/F section 20 includes a wireless LAN unit terminal 21, a D-sub terminal 22, an HDMI1 terminal 23, an HDMI2 terminal 24, a USB1 terminal 25, a USB2 terminal 26, and a LAN terminal 27, as shown in FIG. 3. The wireless LAN unit terminal 21 is a terminal to which a wireless LAN unit that allows wireless LAN communication can be attached. The wireless LAN unit attached to the wireless LAN unit terminal 21 allows the projector 10 to perform wireless LAN communication with a PC or any other apparatus. The wireless LAN unit terminal 21 and the LAN terminal 27 are part of the LAN_I/F 270.

Among the terminals described above, the D-sub terminal 22, the HDMI1 terminal 23, and the HDMI2 terminal 24 can receive an image signal as an input but cannot output the position information PS. On the other hand, the wireless LAN unit terminal 21, the USB1 terminal 25, the USB2 terminal 26, and the LAN terminal 27 can receive an image signal as an input and output the position information PS. To input an image signal by using the USB1 terminal 25 or the USB2 terminal 26, however, the external apparatus, such as a PC, needs to have a USB display function of displaying an image by using a USB cable.

The D-sub terminal 22 is a terminal for connecting a PC having an RGB analog output capability to the projector 10 via a D-sub cable and is used to input an analog image signal from the PC. The HDMI1 terminal 23 and the HDMI2 terminal 24 are terminals that comply with the HDMI (registered trademark) standard and allow the projector 10 connected to a PC or any other apparatus via an HDMI cable to receive a digital image signal and voice signal as an input from the PC or any other apparatus.

The USB1 terminal 25 and the USB2 terminal 26 are terminals that comply with the USB standard. For example, when the projector 10 is connected to a PC or any other apparatus via a USB cable, input and output of data signals, such as a digital image signal and voice signal, can be performed between the projector 10 and the PC or any other apparatus. The LAN terminal 27 is a terminal to which a LAN cable can be connected. When the projector 10 is connected to a PC or any other apparatus via a LAN cable, input and output of data signals, such as a digital image signal and voice signal, can be performed between the projector 10 and the PC or any other apparatus.

To allow the projector 10 to act in the operation mode, an interface via which an image signal is inputted and an interface via which the position information PS is outputted are required. In the following description, the interface via which an image signal is inputted is referred to as a first interface, and the interface via which the position information PS is outputted is referred to as a second interface.

The D-sub_I/F 220, the HDMI1_I/F 230, the HDMI2_I/F 240, the USB1_I/F 250, the USB2_I/F 260, and the LAN_I/F 270 can be used as the first interface. The USB1_I/F 250, the USB2_I/F 260, and the LAN_I/F 270 can be used as the second interface, via which the position information PS is outputted. That is, the D-sub_I/F 220, the HDMI1_I/F 230, and the HDMI2_I/F 240 function as the first interface but do not function as the second interface. On the other hand, the USB1_I/F 250, the USB2_I/F 260, and the LAN_I/F 270 function as the first and second interfaces.

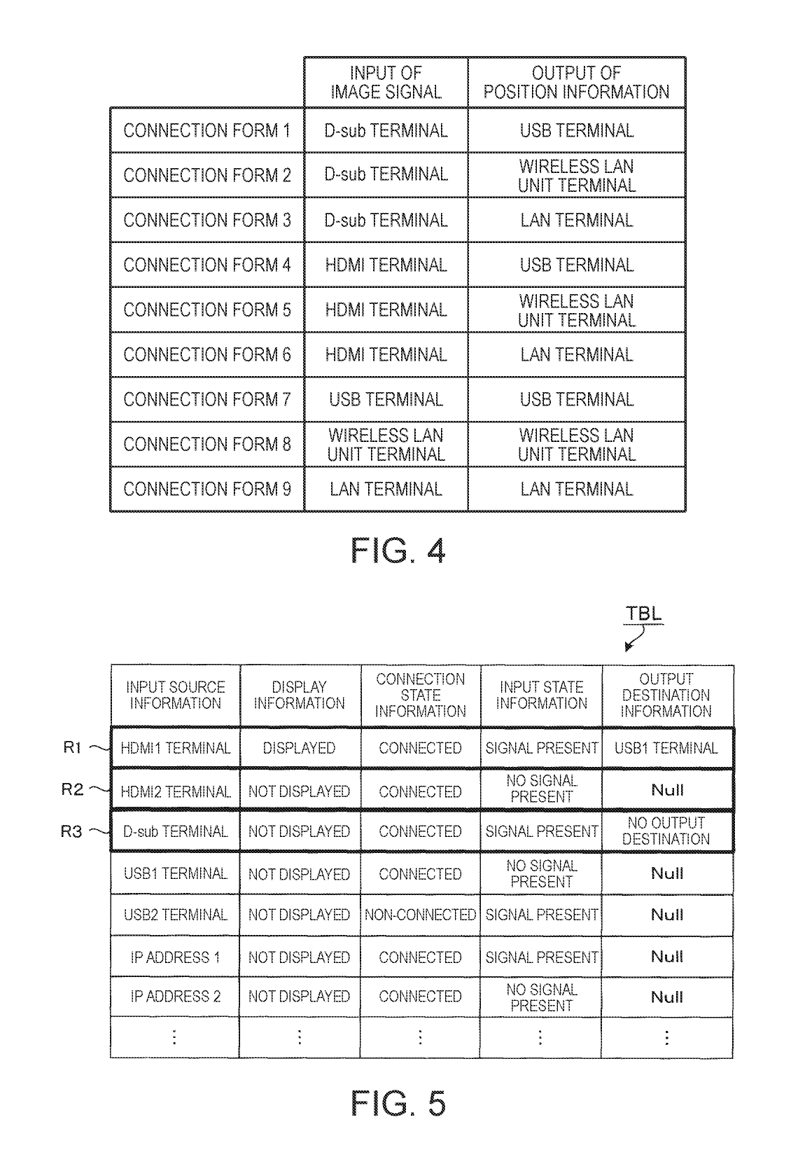

A description will next be made the connection form in accordance with which the projector 10 and a PC are connected to each other in the case where the projector 10 according to the present embodiment acts in the operation mode. FIG. 4 shows examples of the connection form.

In connection forms 1 to 3, a D-sub terminal of the PC is connected to the D-sub terminal 22 of the projector 10 via a D-sub cable, and an image signal is inputted from the PC to the projector 10 via the D-sub cable. The D-sub cable does not allow transmission of the position information PS from the projector 10 to the PC. In view of the fact described above, in the connection form 1, the USB1 terminal 25 or the USB2 terminal 26 of the projector 10 is connected to a USB terminal of the PC via a USB cable, and the position information PS is transmitted from the projector 10 to the PC via the USB cable. In the connection form 2, the position information PS is transmitted from the projector 10 to the PC over a wireless LAN. Further, in the connection form 3, the position information PS is transmitted from the projector 10 to the PC over a wired LAN.

In the connection forms 4 to 6, an HDMI terminal of the PC is connected to the HDMI1 terminal 23 or the HDMI2 terminal 24 via an HDMI cable, and an image signal is inputted from the PC to the projector 10 via the HDMI cable. To transmit the position information PS from the projector 10 to the PC, USB connection, a wireless LAN, and a wired LAN are used, as in the connection forms 1 to 3.

In the connection form 7, the USB terminal of the PC is connected to the USB1 terminal 25 or the USB2 terminal 26 via a USB cable, and an image signal is inputted from the PC to the projector 10 via the USB cable. The position information PS is transmitted from the projector 10 to the PC via the same USB cable.

In the connection form 8, the PC is connected to the projector 10 via a wireless LAN, and an image signal is inputted from the PC to the projector 10 and the position information PS is outputted from the projector 10 to the PC over the wireless LAN.

In the connection form 9, the PC is connected to the projector 10 via a wired LAN, and an image signal is inputted from the PC to the projector 10 and the position information PS is outputted from the projector 10 to the PC over the wired LAN.

The I/F section 20 detects the state of the connection to the external apparatus via each of the interfaces 220 to 270 shown in FIG. 2. The I/F section 20 further detects whether or not an image signal has been inputted from the external apparatus via each of the interfaces 220 to 270. The I/F section 20 outputs detection data D1 representing results of the detection to the control section 30. The connection state is classified into a connected state and a non-connected state. The term “Connected state” refers to a state in which the projector 10 can communicate with the external apparatus, and the term “Non-connected state” refers to a state in which the projector 10 cannot communicate with the external apparatus. The control section 30 may instead monitor the state of the connection to and the state of the image signal input via each of the interfaces in the I/F section 20 and generate the detection data D1.

The control section 30 supplies the I/F section 20 with the position information PS and control data D2 in the operation mode. The control data D2 is data that specifies an interface used to output the position information PS.

The image processing section 40 shown in FIG. 2 includes a frame memory 41. The image processing section 40 performs a variety of types of conversion, such as interlace/progressive conversion, resolution conversion, and color conversion, as appropriate on an image signal inputted via the I/F section 20 and outputted from the control section 30. Having performed the variety of types of conversion, the image processing section 40 generates image data in a preset format and develops the image data on a frame basis in the frame memory 41. In the drawing mode, the position information PS representing the position of the pointing element 90 is outputted from the control section 30 to the image processing section 40. The image processing section 40 performs editing, specifically, adding or deleting image data on figures to or from the image data developed in the frame memory 41 in accordance with the position information PS to generate image data or update the image data.

In the operation mode in the present embodiment, to allow the user to select the destination to which the position information PS, which represents the position of the pointing element 90, is outputted, an output destination identification image (second image) is displayed. Image data GD for displaying the output destination identification image is stored in advance, for example, in the storage section 60, and the control section 30 causes the storage section 60 to output the image data to the image processing section 40. The image processing section 40 develops the image data GD for displaying the output destination identification image in the frame memory 41 on a frame basis. Image data GD for displaying the toolbar 201 is also stored in advance, for example, in the storage section 60, and the control section 30 causes the storage section 60 to output the image data to the image processing section 40. The image processing section 40 develops the image data for displaying the toolbar 201 in the frame memory 41 on a frame basis.

The detection section 50 detects the position of the pointing element 90 on the screen SC and generates the position information PS representing the position of the pointing element 90. The detection section 50 includes an imaging section 51, a light receiving section 52, and a position information generating section 53. The imaging section 51 includes an imaging device formed of a CCD or a CMOS device having an angle of view that covers the range over which the display section 70 displays an image on the screen SC, an interface circuit that reads a value detected with the imaging device and outputs the read value, and other components. The light receiving section 52 receives the infrared signal issued from the infrared light emitter of the pointing element 90.

The position information generating section 53 generates the position information PS, which represents the position of the pointing element 90, on the basis of a signal outputted from the imaging section 51. The position information PS may be any piece of information representing the position where the pointing element 90 comes into contact with the screen SC, which is the display surface on which an image is displayed. The position information PS in this example represents the coordinates of the position on the screen SC at which the front end button 92 of the pointing element 90 points.

Further, the detection section 50 decodes a signal outputted from the light receiving section 52 to generate pointing data D3. The pointing data D3 contains data representing how the front end button 92 of the pointing element 90 is operated. Further, in a case where the front end button 92 of the pointing element 90 is pressed and the position information PS indicates the position of any of the buttons in the toolbar 201, the detection section 50 generates pointing data D3 containing data representing which button has been pressed. The detection section 50 outputs the position information PS and the pointing data D3 to the control section 30.

The storage section 60 is formed of a hard disk drive or a semiconductor memory and stores the control program P, which is executed by the control section 30, data processed by the control section 30, and a management table TBL, which will be described later. The storage section 60 further stores the image data GD for displaying the output destination identification image and the toolbar 201 described above. The storage section 60 may instead be provided in a storage device, a server, or any other component external to the projector 10.

The display section 70 includes an illumination system 71, a light modulator 72, and a projection system 73. The illumination system 71 includes a light source formed, for example, of a xenon lamp, an ultrahigh-pressure mercury lamp, an LED (light emitting diode), or a laser light source. The illumination system 71 may further include a reflector and an auxiliary reflector that guide light emitted from the light source to the light modulator 72. The illumination system 71 may still further include, for example, a lens group (not shown) for enhancing optical characteristics of projection light, a polarizer, or a light adjusting element that is disposed on the path to the light modulator 72 and attenuates the amount of light emitted from the light source.

The light modulator 72 includes, for example, three transmissive liquid crystal panels corresponding to the RGB three primary colors and modulates light passing through the liquid crystal panels on the basis of the image data outputted from the image processing section 40 to generate image light. The light from the illumination system 71 is separated into RGB three color light fluxes, which are incident on the corresponding liquid crystal panels. The color light fluxes having passed through and having been modulated by the liquid crystal panels are combined with one another by a light combining system, such as a cross dichroic prism, and the combined light is outputted to the projection system 73.

The projection system 73 includes a zoom lens that enlarges and reduces an image to be projected and performs focal point adjustment, a zoom adjustment motor that adjusts the degree of zooming, a focus adjustment motor that adjusts focusing, a concave mirror that reflects projection light toward the screen SC, and other components. The projection system 73 performs the zoom adjustment and focus adjustment on the image light modulated by the light modulator 72, guides the light having passed through the lens group toward the screen SC via the concave mirror, and forms an image on the screen SC. The specific configuration of the projection system 73 is not limited to the example described above. For example, a configuration using no concave mirror may be used to project the light modulated by the light modulator 72 via a lens on the screen SC for image formation.

The input section 80 includes an operation panel 81 and a remote control light receiver 82. The remote control light receiver 82 receives the infrared signal transmitted by the remote control (not shown) used by the user of the projector 10 in correspondence with the user's button operation. The remote control light receiver 82 decodes the infrared signal received from the remote control to generate operation data D4, which represents the content of the operation performed on the remote control, and outputs the operation data D4 to the control section 30.

The operation panel 81 is provided on an exterior enclosure of the projector 10 and includes a variety of switches and indicator lamps. The operation panel 81 causes the indicator lamps on the operation panel 81 to illuminate or blink as appropriate in accordance with the action state and setting state of the projector 10 under the control of the control section 30. When any of the switches on the operation panel 81 is operated, operation data D4 corresponding to the operated switch is outputted to the control section 30.

In the present embodiment, to switch an interface which is provided in the I/F section 20 and via which an image signal corresponding to an image displayed by the display section 70 is inputted from one to another, an input switch button is provided on the operation panel 81 and the remote control. Whenever the input switch button is pressed, operation data D4 indicating that the input switch button has been pressed is outputted from the input section 80 to the control section 30. Whenever the operation data D4 indicating that the input switch button has been pressed is inputted, the control section 30 carries out the process of sequentially switching the interface via which an image signal is inputted from one to another. For example, in the case where the projector 10 acts in the operation mode, whenever the input switch button is pressed, the interface is switched from one to another in the following order: the D-sub terminal 22→the HDMI1 terminal 23→the HDMI2 terminal 24→the USB1 terminal 25→the USB2 terminal 26→the LAN terminal 27→the wireless LAN unit terminal 21→the D-sub terminal 22. In a case where a plurality of PCs are connected to the projector 10 via the LAN terminal 27 and the wireless LAN unit terminal 21 and each of the PCs outputs an image signal, the source from which an image signal is inputted is switched from one to another on an IP address basis.

The control section 30 is connected to the I/F section 20, the image processing section 40, the detection section 50, the storage section 60, the display section 70, and the input section 80, inputs and outputs data from and to each of the sections, and controls each of the sections.

In the present embodiment, the state of connection to and the state of signal input via each of the interfaces and the destination to which the position information PS is outputted are managed by the management table TBL stored in the storage section 60. The control section 30 writes information to the management table TBL and updates the information in the management table TBL. The control section 30 receives the position information PS generated by the detection section 50 as an input and controls selection of an interface via which the position information PS is outputted from the interfaces of the I/F section 20 on the basis of the management table TBL. Further, whenever a signal outputted from the input section 80 and indicating that the input switch button has been pressed is inputted, the control section 30 carries out the process of successively switching the interface via which an image signal is inputted from one to another.

The control section 30 outputs an image signal inputted via the interface currently selected from the interfaces of the I/F section 20 to the image processing section 40. The control section 30 reads the image data GD representing the output destination identification image and stored in the storage section 60 as required and outputs the image data GD to the image processing section 40.

The control section 30 receives, as an input, the following information outputted from the detection section 50: the position information PS representing the position of the pointing element 90; and the pointing data D3 representing how the front end button 92 of the pointing element 90 is operated. In the operation mode, the control section 30 refers to the management table TBL stored in the storage section 60 and generates the control data D2 that specifies which interface is used to output the position information PS. The control section 30 then outputs the position information PS and the control data D2 to the I/F section 20. Further, in a case where the pointing data D3 contains data indicating that any of the buttons in the toolbar 201 has been pressed, the control section 30 carries out the function corresponding to the button.

The control section 30 detects the content of the user's operation on the basis of the operation data D4 inputted from the input section 80 and controls the image processing section 40 and the display section 70 on the basis of the operation to cause them to display an image on the screen SC. Further, the control section 30 controls the display section 70 on the basis of the operation data D4 to perform focus adjustment, zoom adjustment, diaphragm adjustment, and other types of adjustment.

The management table TBL in the present embodiment will next be described. FIG. 5 shows an example of the data structure of the management table TBL. The management table TBL contains a plurality of records, as shown in FIG. 5. Each record causes input source information, display information, connection state information, input state information, and output destination information to correspond to one another. Immediately after the projector 10 is powered on, the management table TBL is initialized. In the initial state of the management table TBL, the display information, the connection state information, the input state information, and the output destination information are all “Null.”

The input source information is information for identification of an interface via which an image signal can be inputted and shows the interface name of the interface. Examples of the interface name include “D-sub terminal,” “HDMI1 terminal,” “HDMI2 terminal,” “USB1 terminal,” and “USB2 terminal.” The LAN terminal 27 and the wireless LAN unit terminal 21 are so configured that a plurality of PCs can be connected thereto via a wired LAN or a wireless LAN. Therefore, as the input source information, the LAN terminal 27 or the wireless LAN unit terminal 21 is not logged in the form of the interface names thereof, “LAN terminal” or “Wireless LAN unit terminal,” but is logged in the form of the IP addresses of external apparatus connected to the LAN terminal 27 or the wireless LAN unit terminal 21. In the initial state of the management table TBL, “D-sub terminal,” “HDMI1 terminal,” “HDMI2 terminal,” “USB1 terminal,” or “USB2 terminal” is logged as the input source information on a record basis, but no IP address is logged.

The display information represents whether the projector 10 is displaying or not an image based on an image signal inputted via the interface corresponding to the input source information.

The connection state information represents the state of connection between the interface corresponding to the input source information and an external apparatus, such as a PC. Specifically, the connection state information shows “Connected” or “Non-connected.” The state “Connected” is the state in which the projector 10 can communicate with the external apparatus, and the state “Non-connected” is the state in which the projector 10 cannot communicate with the external apparatus. For example, even in the state in which a PC and the projector 10 are connected to each other via an HDMI cable, but if the HDMI cable is broken, the connection state information shows the non-connected state. On the other hand, even in the state in which the connection state information shows the connected state, but if the PC is transmitting no image signal, no image signal is inputted.

The input state information shows “Signal present” representing that an image signal is inputted via the interface corresponding to the input source information and “No signal present” representing that no image signal is inputted.

The output destination information shows, in a case where an interface via which the position information PS is outputted is identified, the interface name of the interface and shows “Null” in a case where an interface via which the position information PS is outputted is unknown. Further, in a case where no position information PS is outputted (in a case where output of position information PS is prohibited), the output destination information shows “No output destination.”

For example, in the example shown in FIG. 5, in the record R1, the input source information shows “HDMI1 terminal,” and the output destination information shows “USB1 terminal.” This state is the state in the connection form 4 shown in FIG. 4. The record R1 shows that in the case where an image signal inputted via the HDMI1 terminal 23, the position information PS should be outputted via the USB1 terminal 25.

In the record R3, the input source information shows “D-sub terminal,” the display information shows “Not displayed,” and the output destination information shows “No output destination.” This state shows that no position information PS is outputted during the period for which an image according to an image signal inputted via the D-sub terminal 22 is displayed.

### 2. Action of Projector in Operation Mode

The action of the projector in the operation mode will next be described. First, the action of outputting the position information PS will be described, and the action of updating the management table TBL will next be described.

### 2-1: Action of Outputting Position Information PS

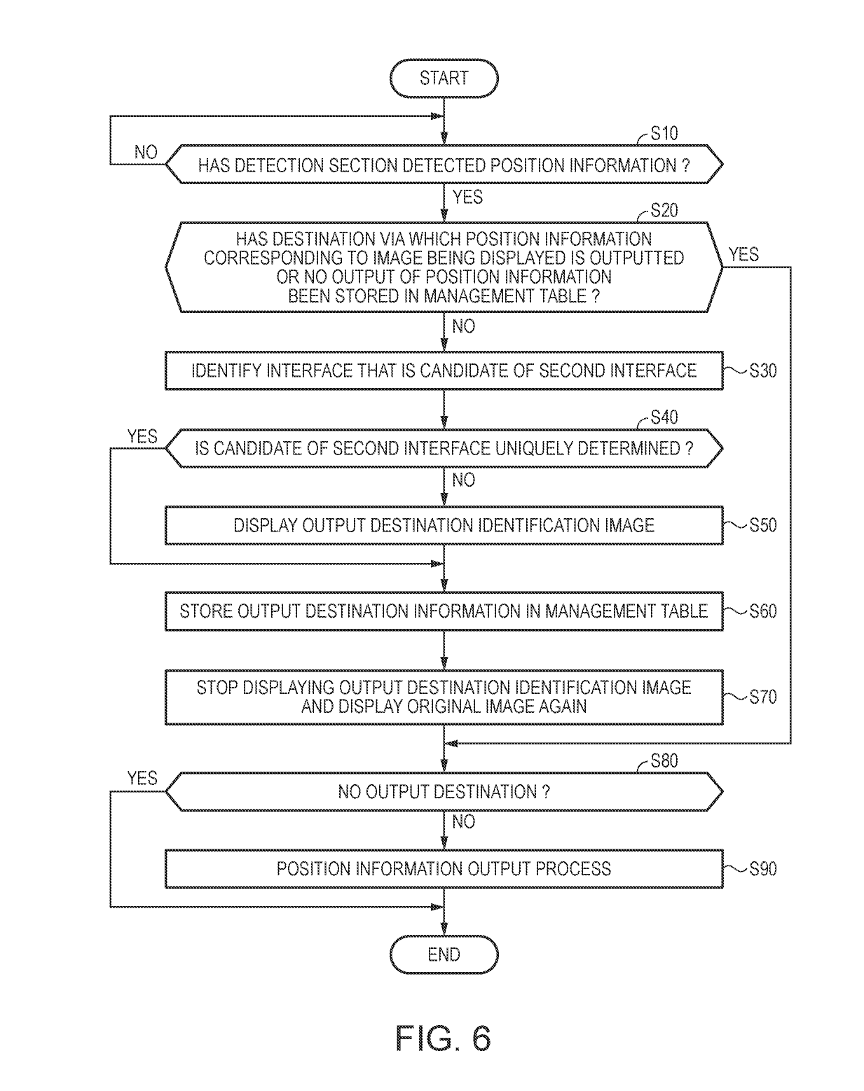

FIG. 6 is a flowchart showing the action of outputting the position information PS. The control section 30 first evaluates whether or not the detection section 50 has detected the position information PS (S10) and repeats the process in step S10 until the position information PS is detected. For example, assume that a home screen of the PC101 is displayed as the first image on the screen SC, as shown in FIG. 1. In this state, further assume that the user holds the shaft 91 of the pointing element 90 and presses the front end button 92, for example, against a folder icon displayed on the screen SC. The detection section 50 of the projector 10 detects the position of the pointing element 90 and generates the position information PS, further generates pointing data D3 representing that the front button 92 of the pointing element 90 has been turned on, and outputs the position information PS and the pointing data D3 to the control section 30. In this case, the control section 30 senses the position information PS outputted from the detection section 50, and the control section 30 determines that the detection section 50 has detected the position information PS.

The control section 30 then evaluates whether or not the destination to which the position information PS corresponding to the image being displayed is outputted or no output of the position information PS has been stored in the management table TBL (S20). Specifically, the control section 30 evaluates whether or not the correspondence between the first interface via which an image signal has been inputted and the second interface via which the position information PS on the position of the pointing element 90 is outputted or the correspondence between the first interface and “No output destination” has been stored in the management table TBL. In this case, the control section 30 refers to the management table TBL, identifies a record indicating that the display information shows the displayed state, and performs the evaluation on the basis of the output destination information in the record.

For example, in the case where the contents stored in the management table TBL are those shown in FIG. 5, the control section 30 identifies the record R1. Since the output destination information in the record R1 shows “USB1 terminal,” the control section 30 determines that the correspondence between the first interface and the second interface has been stored in the management table TBL.

Further, in the management table TBL shown in FIG. 5, in which the output destination information in the record R3 shows “No output destination,” assuming that the display information in the record R3 shows “Displayed,” the control section 30 determines that the correspondence between the first interface and “No output destination” has been stored in the management table TBL.

In the management table TBL shown in FIG. 5, in which the output destination information in the record R2 shows “Null,” assuming that the display information in the record R2 shows “Displayed,” the control section 30 determines that the destination to which the position information PS corresponding to the image being displayed is outputted or no output of the position information PS has not been stored in the management table TBL.

When a result of the evaluation in step S20 is negative (NO in step S20), the control section 30 identifies an interface that is a candidate of the second interface (S30). Specifically, the control section 30 refers to the management table TBL, identifies a record indicating that the display information shows “Displayed,” and evaluates whether or not the interface name, which is the input source information, in the record indicates an interface capable of outputting the position information PS. When the interface name indicates an interface capable of outputting the position information PS, the interface name, which is the input source information, is identified as a candidate of the second interface. In this case, the candidate of the second interface is uniquely determined as only one candidate. The interface capable of outputting the position information PS includes the USB1_I/F 250, the USB2_I/F 260, and the LAN_I/F 270. In the case of the LAN_I/F 270, the input source information shows an IP address.

In a case where the interface name, which is the input source information, is not an interface capable of outputting the position information PS, the control section 30 refers to the management table TBL, extracts a record showing that the display information shows “Not displayed,” the connection state information shows “Connected,” the input state information shows “No signal present,” and the output destination information shows “Null,” and identifies the interface identified by the input source information in the extracted record as a candidate of the second interface. For example, in the management table TBL shown in FIG. 5, assuming a case where the output destination information in the record shows “Null,” the USB1 terminal and the IP address 1 are interfaces that are candidates of the second interface.

That is, in the identification of an interface that is a candidate of the second interface, in the case where the interface via which the image signal being displayed is inputted is an interface capable of outputting the position information PS, this interface has the priority and serves as the first and second interfaces, whereas in the case where the interface via which the image signal being displayed is inputted is not an interface capable of outputting the position information PS, a candidate of the second interface is extracted from the interfaces capable of outputting the position information PS. The reason why the conditions described above include the condition that the connection state information shows “Connected” is that no position information PS can be outputted when the input connection state shows “Non-connected.” Further, the reason why the conditions described above include the condition that the input state information shows “No signal present” is that in the case where the input state information shows “Signal present,” an image signal has been inputted to the interface and no position information PS can therefore be outputted.

The control section 30 then evaluates whether or not a candidate of the second interface is uniquely determined (S40). In a case where there are a plurality of candidates of the second interface, the control section 30 causes the display section 70 to display the output destination identification image on the screen SC and prompts the user to select one of the candidate interfaces (S50).

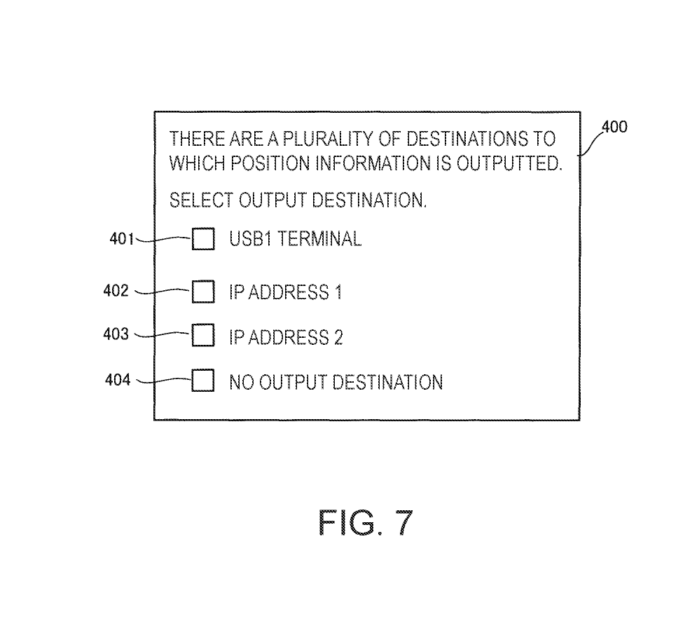

FIG. 7 shows an exemplary output destination identification image 400. The output destination identification image 400 contains a message stating “There are a plurality of destinations to which the position information is outputted. Select an output destination,” as shown in FIG. 7. The message is generated on the basis of the image data GD. The output destination identification image 400 further contains a selection button 401 labeled with “USB1 terminal,” a selection button 402 labeled with “IP address 1,” a selection button 403 labeled with “IP address 2,” and a selection button 404 labeled with “No output destination,” as shown in FIG. 7. As described above, in a case where no correspondence between the first interface and the second interface has been stored in the management table TBL, the output destination identification image 400 showing interfaces that are candidates of the second interface as selection targets is displayed on the screen SC. The interfaces that are candidates of the second interface are in other words interfaces capable of outputting the position information PS. As the candidates of the second interface, an interface capable of outputting the position information PS and connected to the external apparatus may be displayed, but an interface capable of outputting the position information PS but not connected to the external apparatus may not be displayed. The reason why an interface showing “No output destination” is a target to be selected is that the user may use the projector in such a way that even when the projector 10 acts in the operation mode, only an image displayed on a PC is displayed on the screen SC and no operation using the pointing element 90 is performed.

In a case where the user selects an output destination interface from the candidates of the second interface to complete the process in step S50 or there is only one candidate of the second interface and a result of the evaluation in step S40 is affirmative (YES in S40), the control section 30 stores the output destination information in the management table TBL (S60).

In the case where there is only one candidate of the second interface, the control section 30 stores the correspondence between the first interface, via which the image signal being displayed is inputted, and the second interface, via which the position information PS is outputted, in the management table TBL without causing the display section 70 to display the output destination identification image (second image). In the case where the output destination interface is uniquely determined as described above, no output destination identification image is displayed, whereby the user's effort of setting an output destination can be simplified. Further, in the case where the output destination interface is uniquely determined, no inconvenience occurs even when the user specifies no output destination interface.

In the case where there are a plurality of candidates of the second interface, the control section 30 causes the display section 70 to display the output destination identification image and stores the correspondence between one interface selected by the user and the first interface, via which the image signal being displayed is inputted, in the management table TBL.

The control section 30 then causes the display section 70 to stop displaying the output destination identification image and display the original image again (S70). The control section 30 further evaluates whether or not the output destination information shows “No output destination” (S80). Specifically, the control section 30 refers to the management table TBL, identifies a record indicating that the display information shows “Displayed,” and evaluates whether or not the output destination information in the record shows “No output destination.” In the initial state of the management table TBL (state immediately after projector 10 is powered on), all the pieces of output destination information in the management table TBL show “Null.” The case where the output destination information shows “No output destination” is a case where the user has selected “No output destination” in the output destination identification image. When a result of the evaluation in step S80 is affirmative, the control section 30 terminates the entire process without outputting the position information PS.

On the other hand, when a result of the evaluation in step S80 is negative (NO in step S80), the control section 30 carries out a position information output process (S90). In the position information output process, the control section 30 identifies a record indicating that the display information shows “Displayed” and uses the interface indicated by the output destination information in the record to output the position information PS.

### 2-2: Action of Updating Management Table

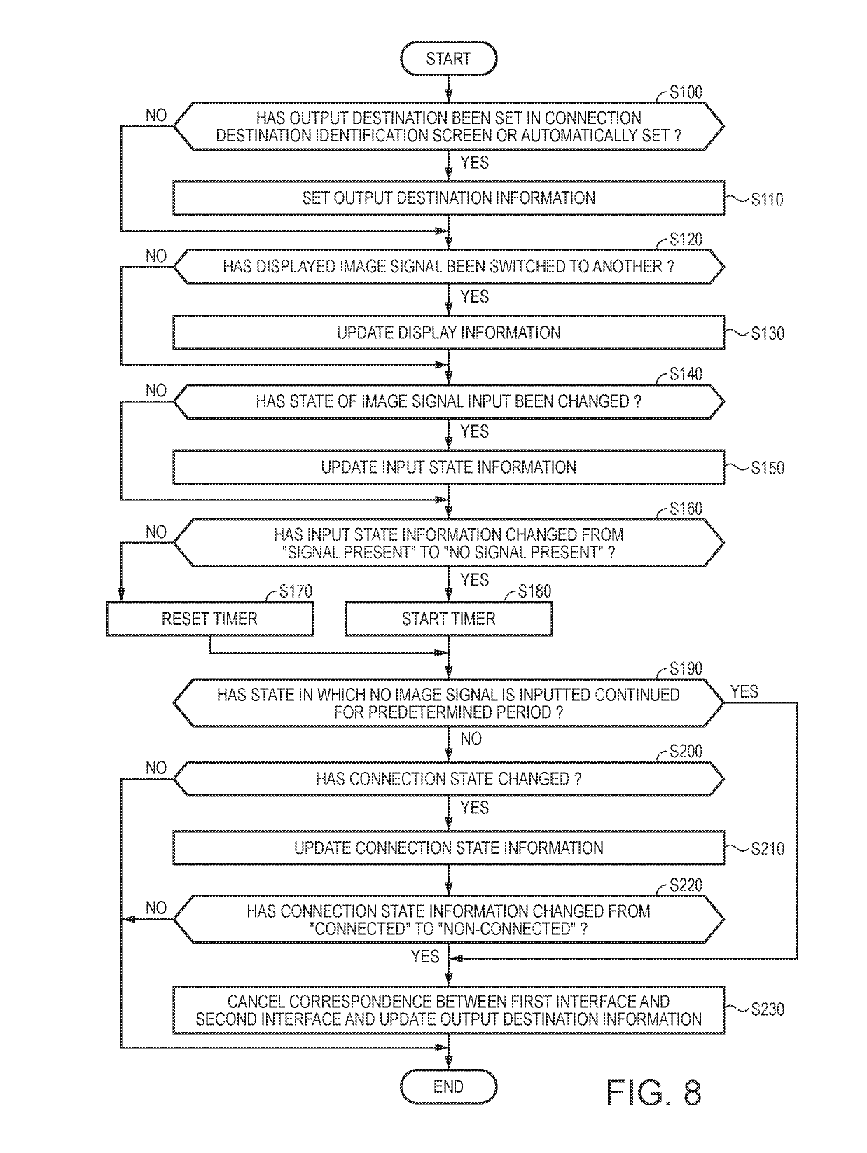

As described above, the control section 30, when the detection section 50 detects the position information PS, updates the output destination information in the management table TBL in a predetermined case. In addition to the predetermined case, the control section 30 updates the management table TBL in some cases. Update of the management table TBL in response to the detection of the position information PS and update of the management table TBL performed on a regular basis will be both described below. FIG. 8 is a flowchart showing the contents of the update process carried out by the control section 30. The control section 30 carries out the update process at predetermined interrupt timing.

The control section 30 first evaluates whether or not the destination to which the position information PS is outputted has been set in a connection destination identification screen or the output destination has been automatically set (S100). When a result of the evaluation is affirmative (YES in S100), the control section 30 sets the output destination information in the management table TBL (S110). The setting of the output destination information is in detail the process in step S60 described with reference to FIG. 6.

When a result of the evaluation is negative (NO in S100), or when the process in step S110 ends, the control section 30 evaluates whether or not the displayed image signal has been switched to another on the basis of the operation data D4 supplied from the input section 80 (S120). When the image signal has been switched to another (YES in S120), the control section 30 updates the display information recorded in the management table TBL (S130). For example, in the case where the contents stored in the management table TBL are those shown in FIG. 5, an image signal inputted via the HDMI1 terminal 23 is displayed. In this state, assume that the displayed image signal is switched to an image signal inputted via the USB2 terminal 26. In this case, the control section 30 updates the display information in the record R1 from “Displayed” to “Not displayed” and updates the display information corresponding to “USB2 terminal,” which is the input source information, from “Not displayed” to “Displayed.” When the image signal is switched as described above, the display information is updated, and the user can therefore grasp the interface via which the currently displayed image signal is being inputted by referring to the management table TBL.

On the other hand, when the displayed image signal has not been switched and a result of the evaluation in step S120 is therefore negative (NO in step S120), or when the process in step S130 ends, the control section 30 evaluates whether or not the state of image signal input supplied via each of the interfaces has been changed on the basis of the detection data D1 supplied from the I/F section 20 (S140). When the input state has been changed (YES in step S140), the control section 30 updates the input state information (S150). Specifically, the control section 30 identifies an interface where the state of image signal input has changed and updates the input state information corresponding to the interface and stored in the management table TBL.

The control section 30 then evaluates whether or not the input state has changed from “Signal present” to “No signal present” (S160). When the input state has changed from “Signal present” to “No signal present” (YES in S160), the control section 30 focuses on the interface where the input state has changed and starts clocking by using a timer (S180). At this point, the control section 30 sets the period having been measured with the timer at zero and starts the clocking from zero. On the other hand, when the input state has changed from “No signal present” to “Signal present” (NO in S160), the control section 30 focuses on the interface where the input state has changed and sets the period measured with the timer at zero (S170). The user can therefore grasp the period for which no image signal is inputted on an interface basis.

The control section 30 then compares each of the periods measured with the timer with a predetermined period (5 seconds, for example) to evaluate whether or not the state in which no image signal is inputted has continued for the predetermined period (S190). When a result of the evaluation is affirmative (YES in S190), the control section 30 updates the output destination information in step S230, which will be described later. On the other hand, when a result of the evaluation is negative (NO in S190), the control section 30 proceeds to the process in step S200.

In step S200, the control section 30 evaluates whether or not the state of connection between each of the interfaces and the external apparatus has changed on the basis of the detection data D1. When the connection state has changed (YES in S200), the control section 30 updates the connection state information corresponding to the interface and stored in the management table TBL (S210).

The control section 30 then evaluates whether or not the connection state information has changed from “Connected” to “Non-connected” (S220). When a result of the evaluation is affirmative (YES in S220), or a result of the evaluation in step S190 is affirmative (YES in S190), the control section 30 cancels the correspondence between the first interface, via which the image signal is inputted, and the second interface, via which the position information PS is outputted, and updates the output destination information (S230).

Specifically, when the output destination information in the record where the connection state information has been updated is not “Null,” the output destination information is updated to “Null.” Further, in a case where the output destination information showing an interface name that coincides with the interface name of the interface where the connection state has changed from “Connected” to “Non-connected” has been stored in the management table TBL, the control section 30 updates the output destination information to “Null.”

In addition, in a case where the state in which no image signal is inputted has continued for the predetermined period and a result of the evaluation in step S190 is therefore affirmative, the control section 30 identifies a record indicating logged input source information showing the interface name that coincides with the interface name of the interface where the state in which no image signal is inputted has continued for the predetermined period, and when the output destination information in the record is not “Null,” the control section 30 updates the output destination information to “Null.”

For example, in the case where the contents stored in the management table TBL are those shown in FIG. 5, input source information showing “D-sub terminal” and output destination information showing “No output destination” are stored in the record R3 with the two pieces of information corresponding to each other. In this state, assume that the D-sub cable connected to the D-sub terminal 22 is pulled out. The connection state information is then updated to “Non-connected.” Further, the output destination information is updated to “Null.” That is, in the case where the state of connection to the input source from which an image signal is inputted is changed to the non-connected state, the information on the destination to which the position information PS is outputted is updated to “Null.” The reason for this is that when the connection state is changed to the non-connected state, the external apparatus that is the source from which the image signal is inputted is likely to be changed to another external apparatus, and if the external apparatus is changed to another and the position information PS is outputted via the interface before the change, the position information PS supposed to be outputted to the other external apparatus is undesirably outputted to the prior external apparatus.

The output destination information in the record R1 shows “USB1 terminal,” and when the USB cable connected to the USB1 terminal 22 is pulled out, the output destination information is updated to “Null”. That is, in the case where the state of connection to the destination to which the position information PS is outputted is changed to the non-connected state, the information on the destination to which the position information PS is outputted is updated to “Null.” The reason for this is that when the connection state is changed to the non-connected state, the external apparatus that is the destination to which the position information PS is outputted is likely to be changed to another external apparatus. If the external apparatus is changed to another, the position information PS is undesirably outputted to an external apparatus different from the source from which the image signal is inputted.

According to the present embodiment, the output destination information is updated in the cases described above, whereby a situation in which the user performs unintended operation on the external apparatus to which the position information PS is outputted can be avoided.

When the state of connection to the external apparatus has not changed, and a result of the evaluation in step S200 is therefore negative (NO in step S200), when the state of connection to the external apparatus has changed from “Non-connected” to “Connected” and a result of the evaluation in step S220 is therefore negative (NO in S220), or when the process in step S230 ends, the control section 30 terminates the process of updating the management table TBL.

### 3. Example of Action in Operation Mode

An example of a specific action of the projector 10 will next be described.

### 3-1: Action Example 1

An action example 1 is assumed to be a case where in the operation mode, five PCs are connected to the projector 10 and the source of the image signal being display is switched from a certain PC to another.

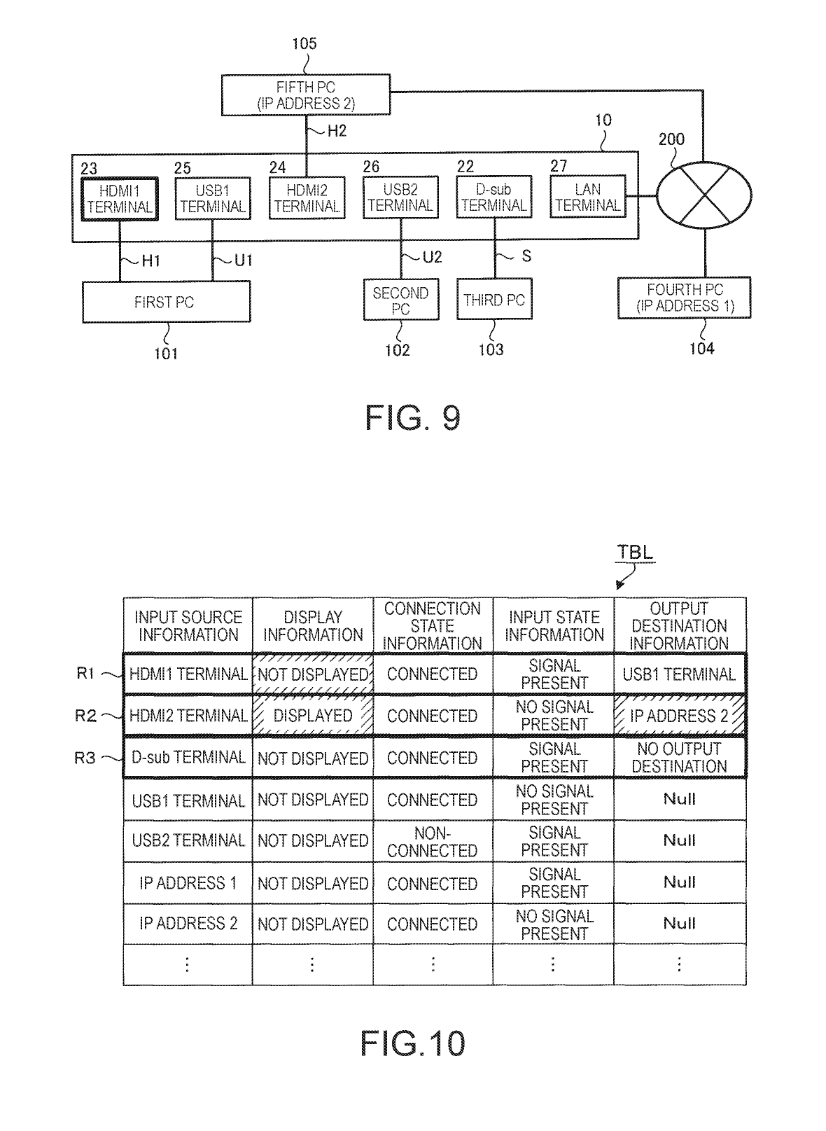

FIG. 9 is a block diagram showing connection between the projector 10 and the PCs in the action example 1. A first PC 101, a second PC 102, a third PC 103, a fourth PC 104, and a fifth PC 105 are connected to the projector 10, as shown in FIG. 9.

The projector 10 is displaying an image corresponding to an image signal inputted from the first PC 101 via an HDMI cable H1. In this state, the position information PS is outputted from the projector 10 to the first PC 101 via a USB cable U1. Further, an image signal is inputted from the second PC 102 to the projector 10 via a USB cable U2. An image signal is still further inputted from the third PC 103 to the projector 10 via a D-sub cable S. An image signal is further inputted from the fourth PC 104 to the projector 10 via a LAN 200. The IP address 1 is allocated to the fourth PC 104. An image signal is further inputted from the fifth PC 105 to the projector 10 via an HDMI cable H2. In addition, the fifth PC 105 is connected to the projector 10 via the LAN 200, and the IP address 2 is allocated to the fourth PC 105.

In this state, the contents stored in the management table TBL are, for example, those shown in FIG. 5. Assume now that the user operates the remote control to switch the source from which the image signal is inputted from the HDMI1 terminal 23 to the HDMI2 terminal 24.

Thereafter, when the user uses the pointing element 90 to perform operation on the screen SC, the detection section 50 detects the position information PS. At this point, the control section 30 refers to the management table TBL and checks if the destination to which the position information PS is outputted has been recorded as the output destination information corresponding to the HDMI2 terminal 24 (S20 shown in FIG. 6). In the management table TBL shown in FIG. 5, the HDMI2 terminal 24 is logged as the input source information in the record R2, and “Null” is logged as the output destination information. That is, to display an image signal inputted via the HDMI2 terminal 24, the projector 10 does not know which interface is used to output the position information PS.

The control section 30 then displays the output destination identification image showing interfaces that are candidates of the second interface via which the position information PS is outputted (S50 shown in FIG. 6). In this example, the control section 30 causes the display section 70 to display an output destination identification image containing “No output destination” as a target to be selected in addition to the USB terminal 26, the IP address 1, and the IP address 2 as the candidates of the second interface. In this example, the control section 30 causes the display section 70 to display the output destination identification image shown in FIG. 7.

Assume now that the user presses the selection button 403 to select the IP address 2. The contents in the management table TBL are then updated and changed to those shown in FIG. 10. In FIG. 10, the hatched portion differs from the corresponding portion in FIG. 5. The control section 30 controls the I/F section 20 to cause it to output the position information PS to the IP address 2.

In the case where the image signal displayed by the display section 70 is switched to another, candidates of the second interface via which the position information PS is outputted are so displayed that the user can select one from the candidates, as described above, whereby the situation in which the position information PS is outputted to the prior external apparatus and the user performs unintended operation on the external apparatus can be avoided in advance.

Further, even in the case where the image signal displayed by the display section 70 is switched to another, the input source information showing “HDMI1 terminal” and the output destination information showing “USB1 terminal” are logged in the record R1 with the two pieces of information corresponding to each other. Therefore, in a case where the image signal displayed by the display section 70 is switched from an image signal inputted via the HDMI2 terminal 24 to an image signal inputted via the HDMI1 terminal 23 again, no output destination identification image needs to be displayed. When the output destination identification image is displayed and the user selects an interface via which the position information PS is outputted as described above, the user does not need to perform the interface setting again except a case, for example, where the connection state changes. The user's effort of setting an interface via which the position information PS is outputted can therefore be simplified.

### 3-2: Action Example 2

An action example 2 is assumed to be a case where the five PCs 101 to 105 are connected to the projector 10, as shown in FIG. 9 and as in the action example 1, and the user operates the remote control to switch the source from which an image signal is inputted from the HDMI1 terminal 23 to the USB2 terminal 26.

In this case, the control section 30 refers to the management table TBL to check if the destination to which the position information PS is outputted is recorded as the output destination information corresponding to the USB2 terminal 26 (S20 shown in FIG. 6). In the management table TBL shown in FIG. 5, “Null” is logged as the output destination information in the record where the USB2 terminal 26 is logged as the input source information. That is, to display the image signal inputted via the USB2 terminal 26, the projector 10 does not know which interface is used to output the position information PS.

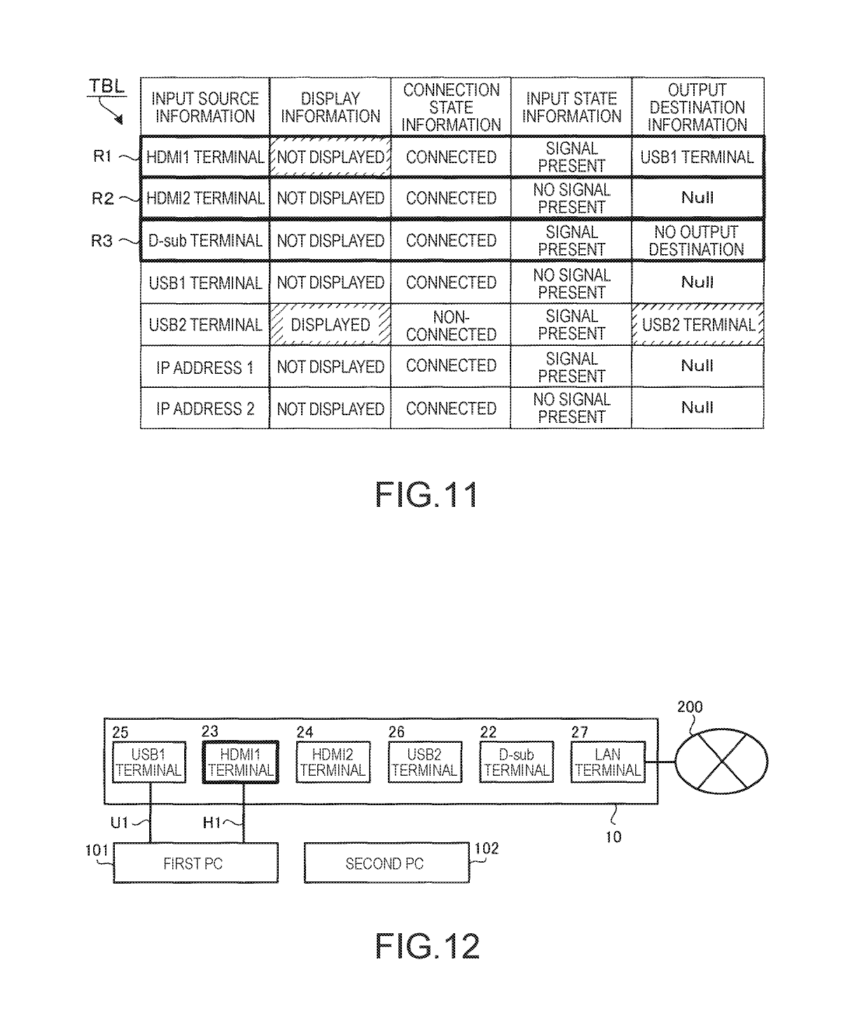

To address the situation described above, the control section 30 identifies an interface that is a candidate of the second interface via which the position information PS is outputted (S30 shown in FIG. 6). In the action example 2, however, the interface via which an image signal is inputted is the USB2 terminal 26, and the USB2 terminal 26 can be used to output the position information PS. In the case of an interface capable of inputting an image signal and outputting the position information PS as described above, it is unnecessary to display the output destination identification image to prompt the user for interface selection. The control section 30 therefore identifies only the USB2 terminal 26 as a candidate of the second interface. The control section 30 then updates the management table TBL as shown in FIG. 11 without causing the display section 70 to display the output destination identification image.

The control section 30 then controls the I/F section 20 to cause it to output the position information PS via the USB2 terminal 26.

In this manner, in the case where an image signal displayed by the display section 70 is switched to another, if an image signal is inputted via an interface capable of inputting an image signal and outputting the position information PS, the second interface via which the position information PS is outputted can be uniquely determined. Thus, no output destination identification image needs to be displayed, whereby user's effort of setting an interface via which the position information PS is outputted can be simplified.

### 3-3: Action Example 3

In an action example 3, assume that the projector 10 is connected to the first PC 101 via the HDMI cable H1 and the USB cable U1, as shown in FIG. 12. The projector 10 is displaying an image according to an image signal inputted via the HDMI1 terminal 23 on the screen SC and outputting the position information PS to the first PC 101 via the USB1 terminal 25.

In this state, the user pulls out the HDMI cable H1 from the first PC 101 with the HDMI cable connected to the projector 10 and connects the HDMI cable H1 to the second PC 102. Now, assume that an image based on an image signal outputted from the second PC 102 is displayed.

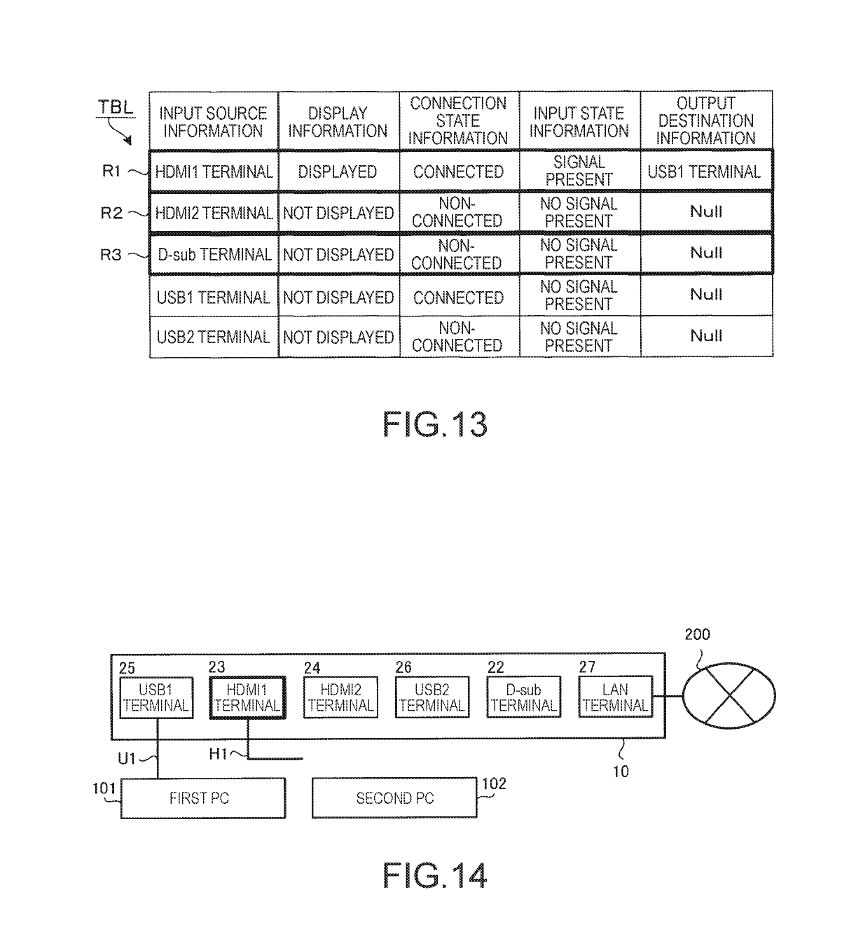

FIG. 13 shows the contents stored in the management table TBL in the case of the connection state shown in FIG. 12. In the record R1, “HDMI1 terminal” is logged as the input source information, and “USB1 terminal” is logged as the output destination information, as shown in FIG. 13. That is, the correspondence between the HDMI1 terminal 23 that is the first interface, via which an image signal is inputted, and the USB1 terminal 25 that is the second interface, via which the position information PS is outputted, has been stored in the management table TBL.

In this state, when the HDMI cable H1 is pulled out from the first PC 101, the connection state changes to that shown in FIG. 14. In this state, the projector 10 is connected to the first PC 101 via the USB cable U1.

When the HDMI cable H1 is pulled out from the first PC 101, the state of connection to the HDMI1 terminal 23 changes from “Connected” to “Non-connected.” The control section 30 then updates the connection state information in the management table TBL (S210 in FIG. 8) and further cancels the correspondence between the first interface and the second interface in the management table TBL (S230 in FIG. 8). Further, when the HDMI cable H1 is pulled out from the first PC 101, no image signal is inputted to the projector 10, and the control section 30 therefore updates the input state information to “No signal present.”

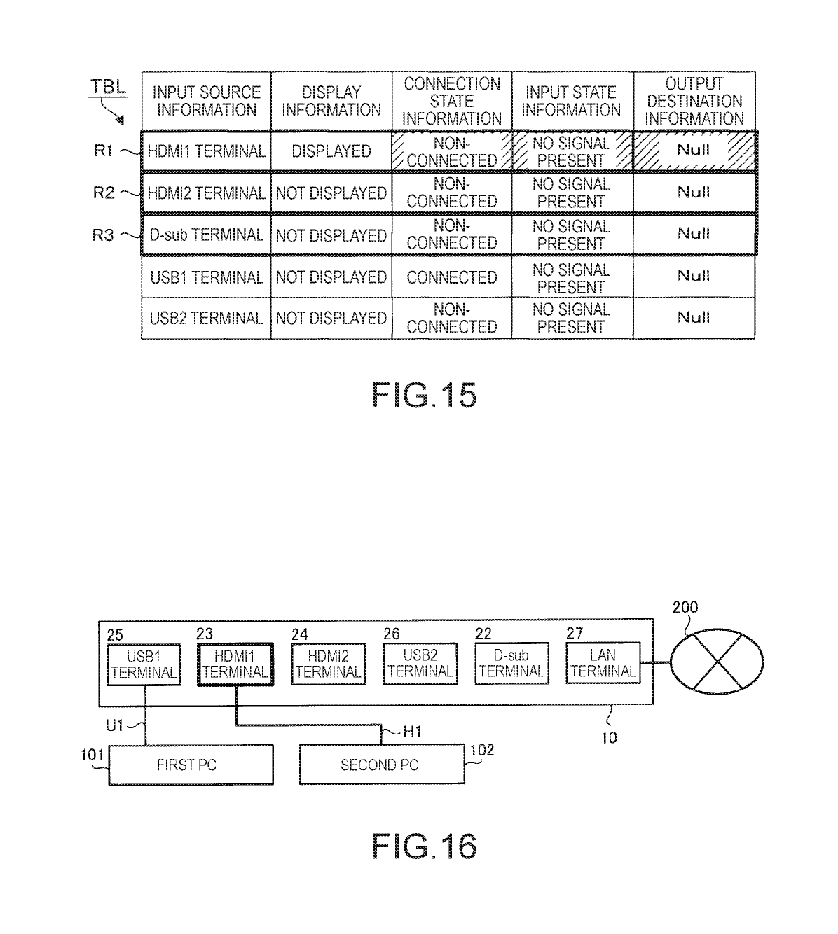

FIG. 15 shows the contents stored in the management table TBL after the correspondence described above is canceled. In FIG. 15, the hatched portion differs from the corresponding portion in FIG. 13. That is, in the record R1, the connection state information shows “Non-connected,” the input state information shows “No signal present,” and the output destination information shows “Null.”

When the HDMI cable H1 is connected to the second PC 102, the connection state changes to that shown in FIG. 16. In this state, an image signal from the second PC 102 is inputted from the second PC 102 via the HDMI cable to the HDMI1 terminal 23 of the projector 10. On the other hand, the USB1 terminal 25 is connected to the first PC 101.

In the connection state shown in FIG. 16, when the user uses the pointing element 90 to perform operation on the screen SC, the detection section 50 detects the position information PS. The output destination information in the record R1 in the management table TBL is “Null,” as described above, and the projector 10 does not know which interface is used to output the position information PS.

The control section 30 then identifies an interface that is a candidate of the second interface, via which the position information PS is outputted (S30 shown in FIG. 6). The candidate in this case is the USB2 terminal. The reason why the USB2 terminal is a candidate of the second interface is that the projector 10 can recognize that the HDMI cable H1 has been pulled out from the first PC 101 but cannot determine whether the pulled-out HDMI cable H1 is connected to the first PC 101 again or connected to another PC. If the HDMI cable H1 is connected to the first PC 101 again, the position information PS only needs to be outputted via the USB1 terminal 25, and the USB1 terminal 25 is therefore a candidate of the second interface.

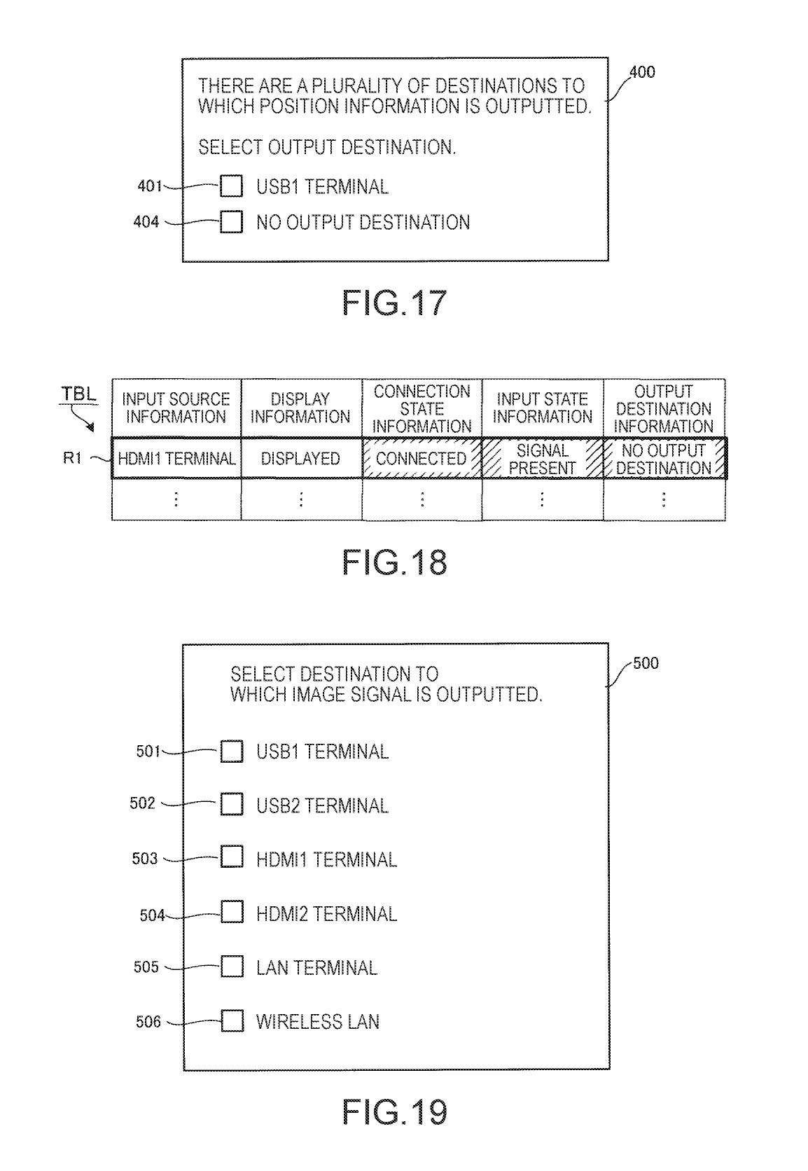

The control section 30 then causes the display section 70 to display the output destination identification image (S50 shown in FIG. 6). In this example, “USB1 terminal” and “No output destination” are displayed as a target to be selected, as shown in FIG. 17.

At this point, when the user selects the selection button 404, which is labeled with “No output destination,” in the output destination identification image 400 with the pointing element 90, the control section 30 stores “No output destination” as the output destination information in the record R1 in the management table TBL (S60 shown in FIG. 6). As a result, the contents stored in the record R1 in the management table TBL change to those shown in FIG. 18. In FIG. 18, the hatched portion differs from the corresponding contents stored in the management table TBL shown in FIG. 15. In this example, since the HDMI1 terminal 23 is connected to the second PC 102 via the HDMI cable H1 and an image signal is inputted via the HDMI1 terminal 23, the connection state information showing “Connected” and the input state information showing “Signal present” are logged in the record R1.

In this state, even when the front end button 92 of the pointing element 90 is pressed against an image screen on the screen SC, no position information PS on the position of the pointing element 90 is outputted from the projector 10. Therefore, the user will not perform operation in the operation mode on the screen displayed by the first PC 101 but not displayed on the screen SC, whereby a situation in which the first PC 101 wrongly acts can be reliably avoided.

### 4. Variations

The invention is not limited to the embodiment described above, and a variety of changes that will, for example, be described below can be made to the embodiment. Further, arbitrarily selected one or more of the following aspects and embodiments of the variations can be combined with each other as appropriate.

### 4-1: Variation 1

In the embodiment described above, the output destination information is selected by the user from pieces of output destination information in the output destination identification image displayed on the screen SC except the case where the output destination is uniquely determined, but the invention is not limited to the embodiment. The destination to which the position information PS is outputted may be identified on the basis of any piece of information outputted from a PC connected to the projector 10 as long as the information allows identification of the destination to which the position information PS is outputted.

In this case, the projector 10 is connected to the PC at least via a wired LAN or a wireless LAN. Further, the PC stores an application program that specifies an interface to which the PC outputs an image signal among the interfaces of the projector 10. When the PC executes the application program, the PC displays an input source identification image. FIG. 19 shows an example of an input source identification image 500 displayed by the PC. The input source identification image 500 contains a selection button 501 labeled with “USB1 terminal,” a selection button 502 labeled with “USB2 terminal,” a selection button 503 labeled with “HDMI1 terminal,” a selection button 504 labeled with “HDMI2 terminal,” a selection button 505 labeled with “LAN terminal,” and a selection button 506 labeled with “Wireless LAN,” as shown in FIG. 19.

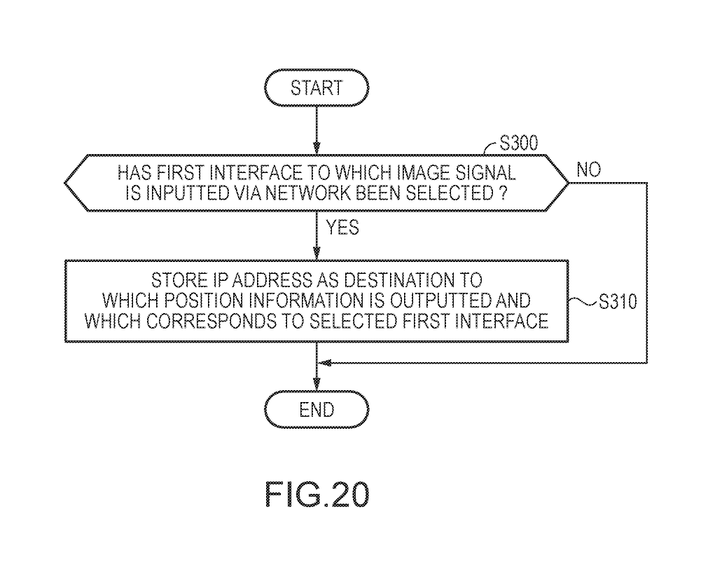

When any of the selection buttons is selected in the PC, an image signal is outputted to the projector 10 via the wired LAN or the wireless LAN via the selected interface, which is the destination to which the image signal is outputted. FIG. 20 is a flowchart showing the contents of a process carried out by the control section 30 in Variation 1. The control section 30 evaluates whether the first interface, to which an image signal is inputted via the wired LAN or the wireless LAN, has been selected (S300), as shown in FIG. 20. After the user identifies an interface via which the image signal is inputted to the projector 10 in the input source identification image 500 shown in FIG. 19, the PC transmits information for identification of the interface that serves as the input source to the projector 10 via the LAN. The control section 30 performs the determination in step S300 on the basis of whether or not the projector 10 has received the information for identification of the interface that serves as the input source. When a result of the determination is affirmative (YES in S300), the control section 30 causes the management table TBL to store the IP address of the PC in the network as the destination to which the position information PS is outputted and which corresponds to the selected first interface (S310).

The setting in the projector 10 can be simplified also by employing the PC-side selection of the first interface as the destination to which an image signal is outputted, as described above.

### 4-2: Variation 2

In the embodiment described above, a pen-shaped device is used as the pointing element 90. The detection section 50 may instead detect the position of the user's finger. In this case, when the user's finger comes into contact with the surface of the screen SC, the processes shown in FIG. 6 may be carried out.

### 4-3: Variation 3

The above embodiment has been described with reference to the configuration in which the processes shown in FIG. 6 are carried out when the front end button 92 of the pointing element 90 is turned on. The invention is, however not limited to the configuration described above. For example, a button that allows the user to set the destination to which the position information PS is outputted in the operation mode is displayed in the toolbar 201, and the processes in step S20 and the following steps shown in FIG. 6 may be carried out when the button is operated.

### 4-4: Variation 4

In the embodiment described above, the display information is logged in the management table TBL, but not necessarily in the invention. Information representing an interface via which the image signal being displayed is inputted may be stored in a register in the CPU 300 or the storage section 60.

In the embodiment described above, the output destination information is allowed to show “No output destination,” but the output destination information may instead show the interface name of an interface via which the position information PS is outputted or “Null.” In this case, in the output destination identification image, a target to be selected is a candidate of the second interface, and “No output destination” is not displayed.

In the embodiment described above, the correspondence between the first interface and the second interface is canceled under the condition that the state in which no image signal is inputted has continued for a predetermined period, but not necessarily in the invention. That is, even in the case where the state in which no image signal is inputted has continued for the predetermined period, the output destination information may be updated, and the correspondence between the first interface and the second interface may not be canceled.

In the embodiment described above, when the state of connection to an interface via which an image signal is inputted or an interface via which the position information PS is outputted changes from “Connected” to “Non-connected,” the output destination information is updated, and the correspondence between the first interface and the second interface is canceled, but not necessarily in the invention. Instead, when the state of connection to one of the interfaces or both the interfaces changes, the correspondence between the first interface and the second interface may not be canceled.

What is claimed is:

1. A display apparatus comprising:
a plurality of interfaces;
a display section that displays a first image according to an image signal on a display surface;
a detection section that detects a position of a pointing element on the display surface and generates position information representing the position of the pointing element;
a storage section that stores a correspondence between a first interface which is one of the plurality of interfaces and via which the image signal is inputted and a second interface which is one of the plurality of interfaces and via which the position information is outputted; and
a control section that carries out the process of outputting the position information via the second interface in a case where the display section is displaying the first image according to the image signal inputted via the first interface and the storage section has stored the correspondence between the first interface and the second interface and when the detection section detects the position of the pointing element, and
identifying an interface via which the position information is outputted in a case where the display section is displaying the first image according to the image signal inputted via the first interface and the storage section has not stored the correspondence between the first interface and the second interface and after the detection section detects the position of the pointing element.

2. The display apparatus according to claim 1, wherein in the process, the control section causes the display section to display a second image containing, as a target to be selected, at least interfaces that are candidates of the second interface corresponding to the first interface, and when one of the candidate interfaces is selected, the control section causes the storage section to store the correspondence between the first interface and the second interface that is the selected one interface.

3. The display apparatus according to claim 2, wherein in the process, the control section causes the display section to display the second image containing a no output destination as a target to be selected in addition to the candidate interfaces, and when the no output destination is selected, the control section causes the storage section to store a correspondence between the first interface and the no output destination.

4. The display apparatus according to claim 2, wherein in the process, in a case where an interface that is a candidate of the second interface corresponding to the first interface is uniquely determined, the control section does not cause the display section to display the second image but causes the storage section to store a correspondence between the first interface and the uniquely determined second interface.

5. The display apparatus according to claim 1, wherein in a case where the first interface is connected to an external apparatus and the storage section has stored the correspondence between the first interface and the second interface, and when the first interface is not connected to the external apparatus, the control section cancels the correspondence stored in the storage section between the first interface and the second interface.

6. The display apparatus according to claim 1, wherein in a case where the first interface is connected to an external apparatus and the storage section has stored the correspondence between the first interface and the second interface, and when a state in which the image signal is not inputted from the external apparatus to the first interface has continued for a predetermined period, the control section cancels the correspondence stored in the storage section between the first interface and the second interface.

7. The display apparatus according to claim 1, wherein in a case where the second interface is connected to an external apparatus and the storage section has stored the correspondence between the first interface and the second interface, and when the second interface is not connected to the external apparatus, the control section cancels the correspondence stored in the storage section between the first interface and the second interface.

8. The display apparatus according to claim 1, wherein the control section switches an action mode of the display apparatus between a mode in which the position information is outputted and a mode in which drawing is performed on the display surface based on the position information.

9. A method for controlling a display apparatus, the method comprising:
acquiring position information representing a position of an pointing element on a display surface on which a first image according to an image signal is displayed;
storing a correspondence between a first interface which is one of a plurality of interfaces and via which the image signal is inputted and a second interface which is one of the plurality of interfaces and via which the position information is outputted; and
carrying out the process of outputting the position information via the second interface in a case where the display section is displaying the first image according to the image signal inputted via the first interface and the storage section has stored the correspondence between the first interface and the second interface and after the position of the pointing element is acquired, and
identifying an interface via which the position information is outputted in a case where the display section is displaying the first image according to the image signal inputted via the first interface and the storage section has not stored the correspondence between the first interface and the second interface and after the position of the pointing element is acquired.
